(19) United States
(12) Patent Application Publication
(10) Pub. No.: US 2016/0281839 A1
(43) Pub. Date: Sep. 29, 2016

(54) TRANSMISSION DEVICE

(71) Applicant: AISIN AW CO., LTD., Anjo-shi, Aichi-ken (JP)

(72) Inventors: Takeshi Torii, Anjo-shi (JP); Tsubasa Deguchi, Anjo-shi (JP); Keisuke Nakashima, Anjo-shi (JP)

(21) Appl. No.: 14/901,891

(22) PCT Filed: Mar. 28, 2014
(86) PCT No.: PCT/JP2014/059320

§ 371 Date: Dec. 29, 2015

(30) Foreign Application Priority Data
Jul. 31, 2013 (JP) 2013-159556

(51) Int. Cl. F16H 57/04; F16H 57/08; F16H 3/66

(52) U.S. Cl. CPC F16H 57/0484; F16H 3/663; F16H 57/082; F16H 57/043; F16H 2200/006; F16H 2200/2007; F16H 2200/2048; F16H 2200/2066; F16H 2200/2082

(57) ABSTRACT

A transmission device that includes a flange provided with first exposing portions and second exposing portions arranged alternately with each other, and is also provided with a plurality of bridges, the first and second exposing portions exposing at least part of the shaft recesses and the outer peripheral portions of the pinion shafts inserted into the shaft support holes, and also exposing the crimp receiving portions of the planetary carrier, and the bridges connecting portions between the adjacent first and second exposing portions on an inner peripheral side of either of the first and second exposing portions.

### BACKGROUND

The present disclosure relates to a transmission device that includes a planetary gear mechanism including a plurality of pinion gears and a planetary carrier for supporting a plurality of pinion shafts inserted into the respective pinion gears, and also includes a friction engagement element including a hub member fixed to the planetary carrier.

Transmission devices of such a type have heretofore been known, each of which includes a planetary gear (planetary gear mechanism) including a plurality of pinion gears, a plurality of pinion shafts each rotatably attached to corresponding one of the pinion gears via a needle bearing, a generally bottomed cylindrical carrier fixed to one ends of the pinion shafts, and a generally annular carrier cover fixed to the other ends of the pinion shafts and mounted on the open side of the carrier, and also includes a friction engagement element including a clutch hub connected to the carrier cover (refer to Japanese Patent Application Publication No. 2009-14148, for example). In this transmission device, the other ends of the pinion shafts are connected to the carrier cover by pins inserted from the outer peripheral side of the carrier cover so as to fix the pinion shafts to the carrier cover and the carrier.

### SUMMARY

However, in the case of the above-described conventional transmission device in which the pinion shafts are connected to the carrier cover via the pins, backlash is formed between the pinion shafts and the carrier cover to leave the pinion shafts and the carrier cover virtually separate from each other, so that the carrier and the carrier cover may fail to have sufficient rigidity. In such a transmission device as described above, the clutch hub connected to the carrier cover also needs to have sufficient rigidity. In addition, such a transmission device as described above is also required to maintain ease of assembly.

Thus, the present disclosure according to an exemplary aspect sufficiently secures rigidity of a planetary carrier included in a planetary gear mechanism and of a hub member of a friction engagement element fixed to the planetary carrier, while maintaining good assemblability of a transmission device.

A transmission device according to an exemplary aspect of the present disclosure includes a planetary gear mechanism including a plurality of pinion gears and a planetary carrier supporting a plurality of pinion shafts respectively inserted into the pinion gears, and also includes a friction engagement element including a hub member fixed to the planetary carrier, wherein an end of each of the pinion shafts is provided with a shaft recess recessed inward in an axial direction from a surface of the end, and provided with an outer peripheral portion surrounding the shaft recess, the planetary carrier has a plurality of shaft support holes each supporting the end of the pinion shaft, and includes crimp receiving portions provided around the shaft support holes so as to receive part of the outer peripheral portions each expanded outward in a radial direction from the shaft recess, the hub member includes an annular flange fixed to a surface of the planetary carrier, which includes the crimp receiving portions, and the flange is provided with first exposing portions and second exposing portions arranged alternately with each other, and is also provided with a plurality of bridges, the first and second exposing portions exposing at least part of the shaft recesses and the outer peripheral portions of the pinion shafts inserted into the shaft support holes, and also exposing the crimp receiving portions of the planetary carrier, and the bridges connecting portions between the adjacent first and second exposing portions on an inner peripheral side of either of the first and second exposing portions.

In this transmission device, the end of each of the pinion shafts of the planetary gear mechanism is provided with the shaft recess recessed inward in the axial direction from the surface of the end, and provided with the outer peripheral portion surrounding the shaft recess. The planetary carrier of the planetary gear mechanism has the shaft support holes each supporting the end of the pinion shaft, and includes the crimp receiving portions provided around the shaft support holes so as to receive part of the outer peripheral portions each expanded outward in the radial direction from the shaft recess. Moreover, the annular flange of the hub member included in the friction engagement element is fixed to the surface of the planetary carrier, which includes the crimp receiving portions. The flange of the hub member is provided with the first and second exposing portions arranged alternately with each other, which expose at least part of the shaft recesses and the outer peripheral portions of the pinion shafts inserted into the shaft support holes, and also expose the crimp receiving portions of the planetary carrier. The flange of the hub member is also provided with the bridges that connect the portions between the adjacent first and second exposing portions on the inner peripheral side of either of the first and second exposing portions.

With this structure, jigs can be inserted into the shaft recesses of the pinion shafts through the first and second exposing portions formed in the hub member, and part of the outer peripheral portions surrounding the shaft recesses can be expanded outward in the radial direction and crimped to the crimp receiving portions of the planetary carrier, using the jigs. In this manner, in the case of this transmission device, the crimping work as described above can be executed after the hub member is fixed to the planetary carrier, so that ease of assembly of the planetary gear mechanism and the friction engagement element including the hub member can be maintained. Crimping the pinion shafts to the planetary carrier allows the pinion shafts to be virtually integrated with the planetary carrier, so that the rigidity of the planetary carrier can be increased. Moreover, forming the first and second exposing portions so as to have opening areas necessary and sufficient for execution of the above-described crimping work can favorably restrain reduction in rigidity of the hub member associated with the formation of the first and second exposing portions, and can ensure a sufficient abutment area between the flange and the planetary carrier to tightly fix the hub member to the planetary carrier. In addition, the bridges connecting the portions between the adjacent first and second exposing portions are provided on the inner peripheral side of either of the first and second exposing portions, so that the rigidity of the hub member can be further sufficiently ensured. As a result, in the case of this transmission device, ease of assembly is favorably maintained, and, at the same time, the rigidity of the planetary carrier included in the planetary gear mechanism and the hub member of the friction engagement element fixed to the planetary carrier can be sufficiently ensured.

The first exposing portions may be formed by cutting out the flange from an inner periphery toward an outer periphery of the flange; the second exposing portions may be arranged further outward in the radial direction than the first exposing portions; and the bridges may connect portions between the adjacent first and second exposing portions on the inner peripheral side of the second exposing portions. In this manner, by connecting the portions between the adjacent first and second exposing portions on the inner peripheral side of the second exposing portions arranged further outward in the radial direction than the first exposing portions, the bridges can be provided on the inner peripheral side of the second exposing portions to ensure the rigidity of the hub member while ensuring the opening areas of the second exposing portions. The bridges can be used as supporting parts (fixing parts) while the first and second exposing portions are processed, so that deformation of the flange can be favorably reduced. As a result, the flange can accurately abut on the surface of the planetary carrier, which includes the above-described crimp receiving portions, and the hub member can be more tightly fixed to the planetary carrier.

Moreover, the pinion gears may include a plurality of inner pinion gears each meshing with a sun gear and a plurality of outer pinion gears each meshing with corresponding one of the inner pinion gears and a ring gear; the first exposing portions may expose at least part of the shaft recesses and the outer peripheral portions of the pinion shafts inserted into the inner pinion gears, and may also expose the crimp receiving portions of the planetary carrier; and the second exposing portions may expose at least part of the shaft recesses and the outer peripheral portions of the pinion shafts inserted into the outer pinion gears, and may also expose the crimp receiving portions of the planetary carrier. In this manner, the present disclosure may be applied to a transmission device including a double-pinion type planetary gear mechanism.

Each of the pinion shafts may be provided with an in-shaft oil passage extending from the shaft recess toward another end of the pinion shaft; the hub member may include a cylindrical portion extending from an outer peripheral portion of the flange and fitted to a friction engagement plate; an annular oil receiver is disposed inside the cylindrical portion of the hub; and the oil receiver may include an oil collecting portion that receives oil splashed from inside and a plurality of insert portions each having an oil passage communicating with the oil collecting portion and inserted into the in-shaft oil passage through corresponding one of the first or second exposing portions and the shaft recess. This structure allows the oil receiver to be arranged on a side of the flange of the hub member opposite from the pinion shafts, that is, inside the cylindrical portion of the hub member, so that the oil collecting portion can be formed larger. As a result, the oil collecting portion can receive a larger amount of the oil splashed from inside, and can introduce a larger amount of the oil from the oil passages of the insert portions that are inserted in the in-shaft oil passages of the pinion shafts, through the first and second exposing portions of the hub member and the shaft recesses, to the in-shaft oil passages. Thus, it is possible to favorably supply the oil to members to be lubricated and cooled, which are included in the planetary gear mechanism.

Moreover, the hub member may be fixed by welding to the planetary carrier, and the planetary carrier may include a plurality of projections that support an inner periphery of the flange of the hub member. This structure causes the projections of the planetary carrier to support the inner periphery of the flange of the hub member, so that the hub member can be accurately positioned with respect to the planetary carrier. Thus, the hub member can be accurately fixed by welding to the planetary carrier.

### BRIEF DESCRIPTION OF THE DRAWINGS

FIG. 1 is a schematic structure diagram of a power transmission device including an automatic transmission serving as a transmission device according to the present disclosure.

FIG. 2 is an operation table representing relationship between shift speeds of the automatic transmission of FIG. 1 and operating states of clutches and brakes.

FIG. 3 is a partial sectional view showing a main part of the automatic transmission of FIG. 1.

FIG. 4 is a perspective view showing a planetary carrier of a planetary gear mechanism included in the automatic transmission of FIG. 1.

FIG. 5 is a front view showing the planetary carrier of the planetary gear mechanism included in the automatic transmission of FIG. 1.

FIG. 6 is a perspective view showing a hub member of one of the clutches included in the automatic transmission of FIG. 1.

### DETAILED DESCRIPTION OF EMBODIMENTS

The following describes modes for carrying out the present disclosure with reference to the drawings.

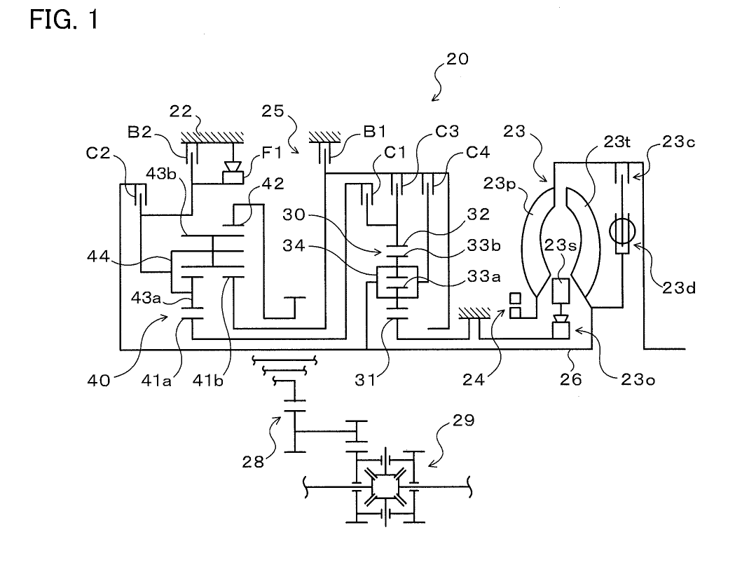

FIG. 1 is a schematic structure diagram of a power transmission device 20 including an automatic transmission 25 serving as a transmission device according to the present disclosure. The power transmission device 20 shown in FIG. 1 is connected to a crankshaft of an engine (not shown) mounted on a front-wheel drive vehicle, and can transmit power from the engine to right and left driving wheels (front wheels, not shown). As shown in FIG. 1, the power transmission device 20 includes, for example, a transmission case 22, a starting device (fluid transmission apparatus) 23 accommodated in the transmission case 22, an oil pump 24, the automatic transmission 25, a gear mechanism (gear train) 28, and a differential gear (differential mechanism) 29.

The starting device 23 is structured as a torque converter that includes, for example, a pump impeller 23p on the input side, which is connected to the crankshaft of the engine; a turbine runner 23t on the output side, which is connected to an input shaft (input member) 26 of the automatic transmission 25; a stator 23s that is disposed inside the pump impeller 23p and the turbine runner 23t, and regulates the flow of hydraulic oil from the turbine runner 23t to the pump impeller 23p; a one-way clutch 23o that restricts the direction of rotation of the stator 23s to one direction; a lock-up clutch 23c; and a damper mechanism 23d. The starting device 23 may, however, be structured as a fluid coupling that does not include the stator 23s.

The oil pump 24 is structured as a gear pump that includes, for example, a pump assembly including a pump body and a pump cover, an external gear connected to the pump impeller 23p of the starting device 23 via a hub, and an internal gear meshing with the external gear. Driven by the power from the engine, the oil pump 24 suctions the hydraulic oil (ATF) reserved in an oil pan (not shown), and feeds the hydraulic oil with pressure to a hydraulic control device (not shown) that generates hydraulic pressure required by the starting device 23 and the automatic transmission 25.

The automatic transmission 25 is structured as an eight-speed transmission. As shown in FIG. 1, the automatic transmission 25 includes, in addition to the input shaft 26, a double-pinion type first planetary gear mechanism 30, a Ravigneaux type second planetary gear mechanism 40, four clutches C1, C2, C3, and C4 and two brakes B1 and B2 for changing a power transmission path from the input side to the output side, and a one-way clutch F1.

The first planetary gear mechanism 30 of the automatic transmission 25 includes a sun gear 31 that is an external gear, a ring gear 32 that is an internal gear disposed concentrically with the sun gear 31, a plurality of inner pinion gears 33a each meshing with the sun gear 31, a plurality of outer pinion gears 33b each of which meshes with corresponding one of the inner pinion gears 33a and the ring gear 32 and is located outside the inner pinion gear 33a in the radial direction, and a planetary carrier 34 that rotatably and revolvably holds the set of inner and outer pinion gears 33a and 33b meshing with each other. As shown in FIG. 1, the sun gear 31 of the first planetary gear mechanism 30 is fixed to the transmission case 22, and the planetary carrier 34 of the first planetary gear mechanism 30 is connected to the input shaft 26 so as to be integrally rotatable with the input shaft 26. The first planetary gear mechanism 30 is structured as what is called a reduction gear, reducing the speed of the power transmitted to the planetary carrier 34 serving as an input element, and outputting the power with reduced speed to the ring gear 32 serving as an output element.

The second planetary gear mechanism 40 of the automatic transmission 25 includes a first sun gear 41a and a second sun gear 41b that are external gears; a ring gear 42 that is an internal gear disposed concentrically with the first and second sun gears 41a and 41b; a plurality of short pinion gears 43a meshing with the first sun gear 41a; a plurality of long pinion gears 43b meshing with the second sun gear 41b and the short pinion gears 43a, and also with the ring gear 42; and a planetary carrier 44 that rotatably and revolvably holds the short pinion gears 43a and the long pinion gears 43b. The ring gear 42 of the second planetary gear mechanism 40 serves as an output member of the automatic transmission 25, and the power transmitted from the input shaft 26 to the ring gear 42 is transmitted to the right and left driving wheels via the gear mechanism 28 and the differential gear 29. The planetary carrier 44 is supported by the transmission case 22 via the one-way clutch F1, and the direction of rotation of the planetary carrier 44 is restricted to one direction by the one-way clutch F1.

The clutch C1 is a multi-plate friction hydraulic clutch (friction engagement element) that includes a hydraulic servo constituted by, for example, a piston, a plurality of friction plates and mating plates, and an oil chamber supplied with the hydraulic oil, and that can connect the ring gear 32 of the first planetary gear mechanism 30 with the first sun gear 41a of the second planetary gear mechanism 40 and release the connection therebetween. The clutch C2 is a multi-plate friction hydraulic clutch that includes a hydraulic servo constituted by, for example, a piston, a plurality of friction plates and mating plates, and an oil chamber supplied with the hydraulic oil, and that can connect the input shaft 26 with the planetary carrier 44 of the second planetary gear mechanism 40 and release the connection therebetween. The clutch C3 is a multi-plate friction hydraulic clutch that includes a hydraulic servo constituted by, for example, a piston, a plurality of friction plates and mating plates, and an oil chamber supplied with the hydraulic oil, and that can connect the ring gear 32 of the first planetary gear mechanism 30 with the second sun gear 41b of the second planetary gear mechanism 40 and release the connection therebetween. The clutch C4 is a multi-plate friction hydraulic clutch that includes a hydraulic servo constituted by, for example, a piston, a plurality of friction plates and mating plates, and an oil chamber supplied with the hydraulic oil, and that can connect the planetary carrier 34 of the first planetary gear mechanism 30 with the second sun gear 41b of the second planetary gear mechanism 40 and release the connection therebetween.

The brake B1 is a hydraulic brake (friction engagement element) that is structured as a band brake or a multi-plate friction brake including a hydraulic servo, and that can fix the second sun gear 41b of the second planetary gear mechanism 40 to the transmission case 22 so that the second sun gear 41b is unrotatable and release the fixation of the second sun gear 41b to the transmission case 22. The brake B2 is a hydraulic brake that is structured as a band brake or a multi-plate friction brake including a hydraulic servo, and that can fix the planetary carrier 44 of the second planetary gear mechanism 40 to the transmission case 22 so that the planetary carrier 44 is unrotatable and release the fixation of the planetary carrier 44 to the transmission case 22. The one-way clutch F1 includes, for example, an inner race, an outer race, and a plurality of sprags, and transmits torque via the sprags when the outer race rotates relative to the inner race in one direction while allowing the inner and outer races to rotate relative to each other when the outer race rotates relative to the inner race in the other direction. The one-way clutch F1 may, however, have a structure, such as a roller clutch structure, other than the sprag clutch structure.

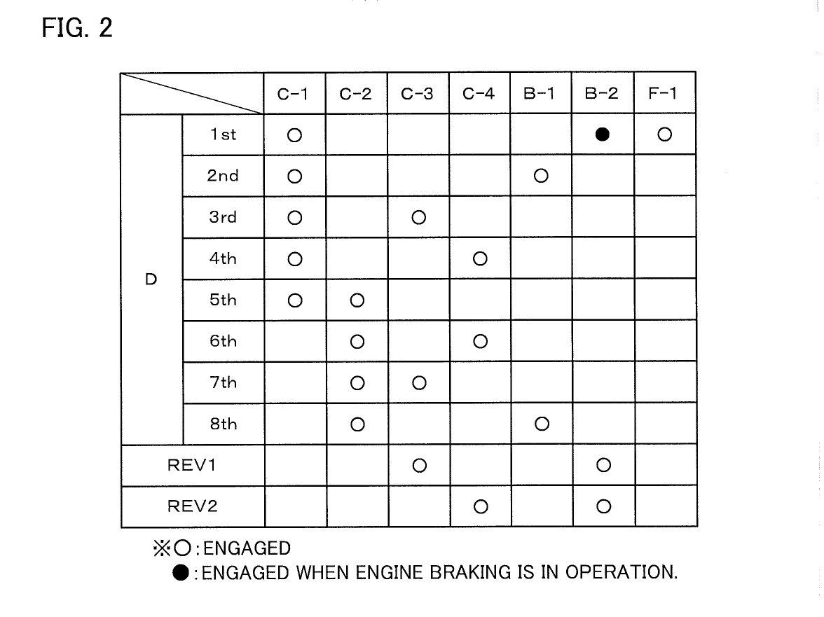

The clutches C1 to C4 and the brakes B1 and B2 operate in response to supply and discharge of the hydraulic oil by the hydraulic control device. FIG. 2 shows an operation table representing relationship of the shift speeds of the automatic transmission 25 and operating states of the clutches C1 to C4, the brakes B1 and B2, and the one-way clutch F1. The automatic transmission 25 places the clutches C1 to C4 and the brakes B1 and B2 in the states shown in the operation table of FIG. 2 so as to provide first to eighth forward shift speeds and first and second reverse shift speeds. At least one of the clutches C1 to C3, other than the clutch C4, and the brakes B1 and B2 may be a meshing engagement element, such as a dog clutch.

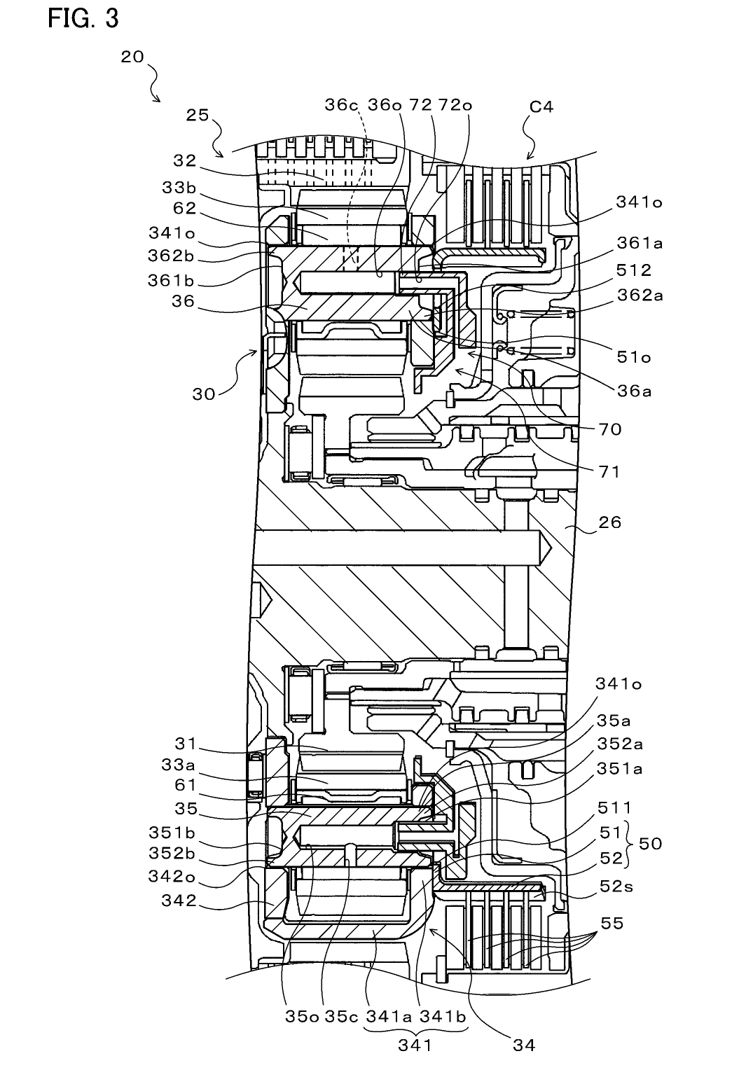

FIG. 3 is a partial sectional view showing a main part of the automatic transmission 25, that is, the structure of the vicinity of the first planetary gear mechanism 30 and the clutch C4. As shown in FIG. 3, a first pinion shaft 35 is inserted in each of the inner pinion gears 33a of the first planetary gear mechanism 30 via a needle bearing 61, and a second pinion shaft 36 is inserted in each of the outer pinion gears 33b via a needle bearing 62. The planetary carrier 34 holds the first pinion shafts 35 and the second pinion shafts 36 so that the inner pinion gears 33a and the outer pinion gears 33b are alternately arranged.

As shown in FIG. 3, the planetary carrier 34 of the first planetary gear mechanism 30 is constituted by a generally cylindrical carrier body 341 and an annular carrier cover 342 fixed to the carrier body 341. The carrier body 341 of the planetary carrier 34 includes an outer peripheral portion 341a extending in the axial direction of the first planetary gear mechanism 30 (hereinafter, simply called the “axial direction”) and an annular portion 341b extending inward in the radial direction of the first planetary gear mechanism 30 (hereinafter, simply called the “radial direction”) from an end of the outer peripheral portion 341a on the clutch C4 side (on the right side in FIG. 3).

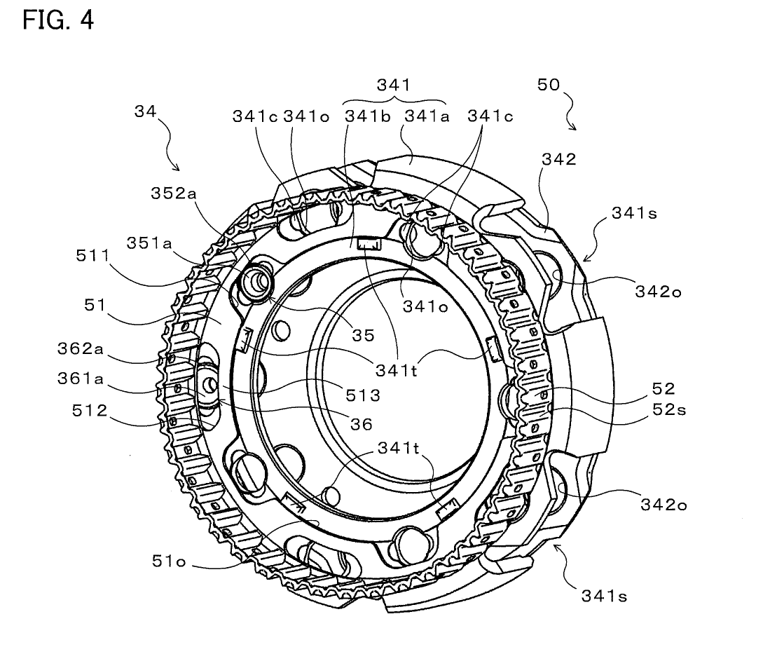

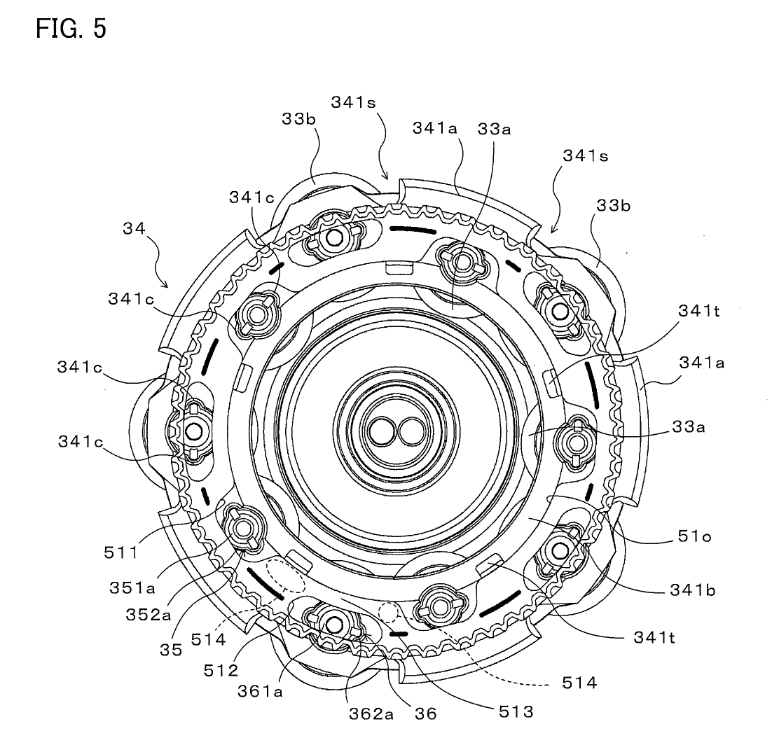

As shown in FIGS. 4 and 5, a plurality of cutout portions 341s are formed in the outer peripheral portion 341a of the carrier body 341 so as to each expose some of the gear teeth provided on the outer periphery of corresponding one of the outer pinion gears 33b. The annular portion 341b of the carrier body 341 has a plurality of shaft support holes 341o for supporting ends 35a and 36a of the first and second pinion shafts 35 and 36, respectively, on the clutch C4 side (on the right side in FIG. 3). The shaft support holes 341o are formed in the annular portion 341b so that the first and second pinion shafts 35 and 36 are alternately arranged and the second pinion shafts 36 are located outside the first pinion shafts 35 in the radial direction. For simplification of explanation, FIG. 3 shows only one of the inner pinion gears 33a and one of the outer pinion gears 33b. Also, for simplification of explanation, FIG. 4 does not show the inner and outer pinion gears 33a and 33b.

The carrier cover 342 of the planetary carrier 34 is disposed so as to face the annular portion 341b of the carrier body 341. As shown in FIG. 3, the outer peripheral portion of the carrier cover 342 is fixed to an end of the outer peripheral portion 341a of the carrier body 341 on the opposite side from the clutch C4 (on the left side in FIG. 3), and the inner peripheral portion of the carrier cover 342 is fixed to the input shaft 26 of the automatic transmission 25. This structure integrates the carrier body 341 and the carrier cover 342 as the planetary carrier 34, and connects the planetary carrier 34 to the input shaft 26 of the automatic transmission 25. The carrier cover 342 includes a plurality of shaft support holes 342o for supporting other ends 35b and 36b of the first and second pinion shafts 35 and 36, respectively, on the opposite side from the clutch C4 (on the left side in FIG. 3). The shaft support holes 342o are formed in the carrier cover 342 so that the first and second pinion shafts 35 and 36 are alternately arranged and the second pinion shafts 36 are located outside the first pinion shafts 35 in the radial direction.

As shown in FIG. 3, the ends 35a and 36a of the first and second pinion shafts 35 and 36 inserted in the shaft support holes 341o of the carrier body 341 are respectively provided with shaft recesses 351a and 361a recessed inward in the axial direction from end surfaces of the ends 35a and 36a, and with cylindrical outer peripheral portions 352a and 362a surrounding the shaft recesses 351a and 361a. In addition, as shown in FIG. 3, the other ends 35b and 36b of the first and second pinion shafts 35 and 36 inserted in the shaft support holes 342o of the carrier cover 342 are respectively provided with shaft recesses 351b and 361b recessed inward in the axial direction from end surfaces of the other ends 35b and 36b, and with cylindrical outer peripheral portions 352b and 362b surrounding the shaft recesses 351b and 361b.

As shown in FIG. 5, the annular portion 341b of the carrier body 341 includes a pair of crimp receiving portions 341c provided around each of the shaft support holes 341o. The pair of crimp receiving portions 341c are formed on a surface on the clutch C4 side of the annular portion 341b so as to expand outward in the radial direction while facing each other and to be recessed inward in the axial direction (toward the carrier cover 342), and receive part of the outer peripheral portions 352a and 362a expanded outward in the radial direction from the shaft recesses 351a and 361a of the first and second pinion shafts 35 and 36. Moreover, in the same way as the carrier body 341, the carrier cover 342 includes a pair of crimp receiving portions (not shown) provided around each of the shaft support holes 342o. The pair of crimp receiving portions receive part of the outer peripheral portions 352b and 362b expanded outward in the radial direction from the shaft recesses 351b and 361b of the first and second pinion shafts 35 and 36. Three or more such crimp receiving portions 341c and the like of the carrier body 341 and the carrier cover 342 may be provided around each of the shaft support holes 341o and 342o.

A clutch hub 50 serving as one of the components of the clutch C4 described above is fixed to the surface of the annular portion 341b of the carrier body 341, which is provided with the crimp receiving portions 341c. As shown in FIGS. 3 to 5, the clutch hub 50 includes: an annular flange 51 fixed to the surface of the annular portion 341b, which includes the crimp receiving portions 341c; and a cylindrical portion 52 that extends from the outer peripheral portion of the flange 51 and is provided with splines 52s on the outer peripheral surface thereof. As shown in FIG. 3, inner peripheral portions of friction engagement plates 55 are fitted to the splines 52s of the cylindrical portion 52.

The flange 51 of the clutch hub 50 includes a center hole 51o, and the inner peripheral surface of the center hole 51o is press-fitted onto a plurality of (five in the present embodiment) projections 341t provided so as to be concentrically located at even intervals on the annular portion 341b of the carrier body 341. This structure allows the projections 341t to support the inner peripheral surface of the center hole 51o, and allows the carrier body 341 to accurately center the flange 51, that is, the clutch hub 50. Moreover, the flange 51 is fixed by welding to the annular portion 341b of the carrier body 341 at locations indicated by a dashed-dotted line in FIG. 5. In this manner, the projections 341t provided on the carrier body 341 supports the inner peripheral surface of the flange 51 (center hole 51o), so that the clutch hub 50 can be accurately positioned (centered) with respect to the carrier body 341, and then the flange 51 of the clutch hub 50 can be accurately fixed by welding to the annular portion 341b of the carrier body 341.

As shown in FIGS. 4 to 6, a plurality of (five in the present embodiment) first exposing portions 511 and a plurality of (five in the present embodiment) second exposing portions 512 are formed in the flange 51 of the clutch hub 50. Each of the first exposing portions 511 is formed in the flange 51 so as to expose at least part of the shaft recess 351a and the outer peripheral portion 352a of the first pinion shaft 35 inserted in corresponding one of the shaft support holes 341o, and also to expose the crimp receiving portions 341c receiving a part of the outer peripheral portion 352a, when viewed from a side opposite from the planetary carrier 34 (from the front side in FIG. 5). Each of the second exposing portions 512 is formed in the flange 51 so as to expose at least part of the shaft recess 361a and the outer peripheral portion 362a of the second pinion shaft 36 inserted in corresponding one of the shaft support holes 341o, and also to expose the crimp receiving portions 341c receiving a part of the outer peripheral portion 362a, when viewed from the side opposite from the planetary carrier 34.

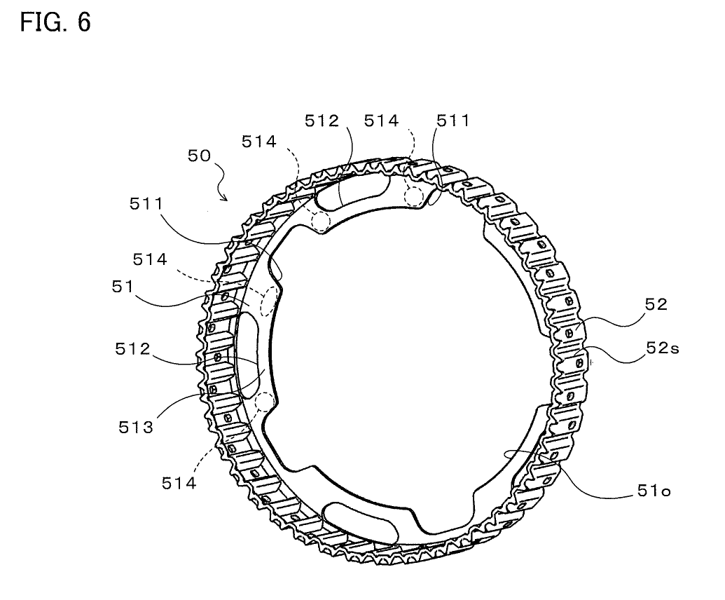

In the present embodiment, as shown in FIGS. 5 and 6, the first exposing portions 511 are formed at even intervals along the peripheral direction of the clutch hub 50 by cutting out the flange 51 at portions overlapping the first pinion shafts 35 from the inner periphery toward the outer periphery up to a substantially central part in the radial direction of the flange 51. Also, as shown in FIGS. 5 and 6, the second exposing portions 512 are formed at even intervals along the peripheral direction of the clutch hub 50 by forming elongated hole-like openings at portions of the flange 51 overlapping the second pinion shafts 36. As a result, the second exposing portions 512 are arranged further outward in the radial direction than the first exposing portions 511, and the first and second exposing portions 511 and 512 are alternately formed in the flange 51 along the peripheral direction of the clutch hub 50. Moreover, a plurality of bridges 513 are provided on the inner peripheral side of the second exposing portions 512, each of the bridges 513 connecting portions between the adjacent first and second exposing portions 511 and 512, that is, connecting protruding portions 514 (portions enclosed by dashed lines in FIGS. 5 and 6) located on both sides of corresponding one of the first exposing portions 511.

The clutch hub 50 structured as described above is welded to the planetary carrier 34 before the inner and outer pinion gears 33a and 33b, the first and second pinion shafts 35 and 36, and the needle bearings 61 and 62 are assembled to the planetary carrier 34. After the inner and outer pinion gears 33a and 33b, the first and second pinion shafts 35 and 36, and the needle bearings 61 and 62 are assembled to the planetary carrier 34 welded to the clutch hub 50, at least part of the shaft recess 351a and the outer peripheral portion 352a of the first pinion shaft 35 and the crimp receiving portions 341c of the carrier body 341 are exposed through each of the first exposing portions 511 of the flange 51. Furthermore, at least part of the shaft recess 361a and the outer peripheral portion 362a of the second pinion shaft 36 and the crimp receiving portions 341c of the carrier body 341 are exposed through each of the second exposing portions 512 of the flange 51.

With this structure, jigs can be inserted into the shaft recesses 351a and 361a of the first and second pinion shafts 35 and 36 through the first and second exposing portions 511 and 512 formed in the flange 51 of the clutch hub 50, and part of the outer peripheral portions 352a and 362a surrounding the shaft recesses 351a and 361a can be expanded outward in the radial direction using the jigs so as to be crimped to the crimp receiving portions 341c of the annular portion 341b of the carrier body 341. As a result, in the case of the automatic transmission 25, the crimping work as described above can be executed after the clutch hub 50 is fixed to the planetary carrier 34, so that ease of assembly of the first planetary gear mechanism 30 and the clutch C4 including the clutch hub 50 can be maintained.

By crimping part of the outer peripheral portions 352a and 362a formed at the ends 35a and 36a of the first and second pinion shafts 35 and 36 to the crimp receiving portions 341c of the carrier body 341, and crimping part of the outer peripheral portions 352b and 362b formed at the other ends 35b and 36b of the first and second pinion shafts 35 and 36 to receiving portions (not shown) of the carrier cover 342, the first and second pinion shafts 35 and 36 can be fixed to the planetary carrier 34 while preventing formation of backlash between: the first and second pinion shafts 35 and 36; and the planetary carrier 34. As a result, the first and second pinion shafts 35 and 36 can be virtually integrated with the planetary carrier 34, so that the rigidity of the planetary carrier 34 can be increased.

Moreover, in the present embodiment, the first and second exposing portions 511 and 512 are formed so as to have opening areas necessary and sufficient for execution of the crimping work described above. This can favorably restrain reduction in rigidity of the clutch hub 50 associated with the formation of the first and second exposing portions 511 and 512, and can ensure a sufficient abutment area between the flange 51 and the planetary carrier 34, that is, a weld length (weld area) between both members to tightly fix the clutch hub 50 to the planetary carrier 34.

As described above, the bridges 513 are provided in the flange 51 so as to connect the protruding portions 514 between the adjacent first and second exposing portions 511 and 512 on the inner peripheral side of the second exposing portions 512 arranged further outward in the radial direction than the first exposing portions 511, so that the rigidity of the clutch hub 50 can be further favorably ensured while ensuring the opening areas of the second exposing portions 512. Moreover, providing the bridges 513 in the flange 51 reduces the overall amount of processing applied to the flange 51 during formation (for example, formation by press work) of the first and second exposing portions 511 and 512, and allows the bridges 513 to be used as supporting parts (fixing parts), so that deformation of the flange 51 can be favorably reduced. As a result, the flange 51 can accurately (without gaps) abut on a surface of the annular portion 341b of the carrier body 341, which includes the above-described crimp receiving portions 341c, and the clutch hub 50 can be more tightly fixed to the planetary carrier 34. As a result of ensuring the rigidity of the clutch hub 50 and reducing the deformation of the flange 51 as described above, the clutch hub 50 can be more accurately positioned (centered) with respect to the carrier body 341 by press-fitting the flange 51 onto the projections 341t of the carrier body 341, so that the flange 51 of the clutch hub 50 can be more accurately fixed by welding to the annular portion 341b of the carrier body 341.

The following describes a lubrication structure of the first planetary gear mechanism 30. As shown in FIG. 3, an in-shaft oil passage 35o extending from the shaft recess 351a on the end 35a side toward the other end 35b is formed in the first pinion shaft 35. The in-shaft oil passage 35o communicates with a radial oil passage 35c extending outward in the radial direction at a substantially central part in the axial direction of the first pinion shaft 35 and opening on the outer peripheral surface of the first pinion shaft 35. An in-shaft oil passage 36o extending from the shaft recess 361a on the end 36a side toward the other end 36b is formed in the second pinion shaft 36. The in-shaft oil passage 36o also communicates with a radial oil passage 36c extending outward in the radial direction at a substantially central part in the axial direction of the second pinion shaft 36 and opening on the outer peripheral surface of the second pinion shaft 36.

An annular oil receiver 70 is disposed inside the cylindrical portion 52 of the clutch hub 50. The oil receiver 70 includes an oil collecting portion 71 for receiving oil splashed from inside the carrier body 341 and the clutch hub 50, and also includes a plurality of insert portions 72 each having an oil passage 72o communicating with the oil collecting portion 71 and inserted into the in-shaft oil passage 35o or 36o through corresponding one of the first or second exposing portions 511 or 512 and the shaft recess 351a or 361a. As shown in FIG. 3, the oil collecting portion 71 of the oil receiver 70 attached to the planetary carrier 34 extends from the inner peripheral side of the annular portion 341b of the carrier body 341 toward the clutch C4 side (the right side in FIG. 3). Also, as shown in FIG. 3, the insert portions 72 extend from the clutch C4 side toward the carrier cover 342 side (the left side in FIG. 3).

This structure allows the oil receiver 70 to be arranged on a side of the flange 51 of the clutch hub 50 opposite from the first and second pinion shafts 35 and 36, that is, inside the cylindrical portion 52 of the clutch hub 50, so that the oil collecting portion 71 can be formed larger. As a result, the oil collecting portion 71 can receive a larger amount of the oil splashed from inside, and can introduce a larger amount of the oil to the in-shaft oil passages 35o and 36o from the oil passages 72o of the insert portions 72 that are inserted in the in-shaft oil passages 35o and 36o of the first and second pinion shafts 35 and 36 through the first and second exposing portions 511 and 512 of the clutch hub 50 and the shaft recesses 351a and 361a. Consequently, the oil for lubrication and cooling can be favorably supplied to members to be lubricated and cooled that are included in the first planetary gear mechanism 30, that is, to the inner and outer pinion gears 33a and 33b and the needle bearings 61 and 62.

As described above, in the automatic transmission 25, the ends 35a and 36a of the first and second pinion shafts 35 and 36 of the first planetary gear mechanism 30 are provided with the shaft recesses 351a and 361a recessed inward in the axial direction from the end surfaces of the ends 35a and 36a and the outer peripheral portions 352a and 362a surrounding the shaft recesses 351a and 361a. The planetary carrier 34 of the first planetary gear mechanism 30 has the shaft support holes 341o supporting the ends 35a and 36a of the first and second pinion shafts 35 and 36, respectively, and includes the crimp receiving portions 341c provided around the shaft support holes 341o so as to receive part of the outer peripheral portions 352a and 362a expanded outward in the radial direction from the shaft recesses 351a and 361a. Moreover, the annular flange 51 of the clutch hub 50 included in the clutch C4 is fixed to the surface of the planetary carrier 34, which includes the crimp receiving portions 341c. Furthermore, the flange 51 of the clutch hub 50 is provided with the first and second exposing portions 511 and 512 that are formed alternately with each other, and is also provided with the bridges 513, where the first and second exposing portions 511 and 512 expose at least part of the shaft recesses 351a and 361a and the outer peripheral portions 352a and 362a of the first and second pinion shafts 35 and 36 inserted into the shaft support holes 341o, and also expose the crimp receiving portions 341c of the planetary carrier 34, and the bridges 513 connect the protruding portions 514 between the adjacent first and second exposing portions 511 and 512 on the inner peripheral side of the second exposing portions 512.

With this structure, jigs can be inserted into the shaft recesses 351a and 361a of the first and second pinion shafts 35 and 36 through the first and second exposing portions 511 and 512 formed in the clutch hub 50, and part of the outer peripheral portions 352a and 362a surrounding the shaft recesses 351a and 361a can be expanded outward in the radial direction and crimped to the crimp receiving portions 341c of the planetary carrier 34, using the jigs. In this manner, in the case of the automatic transmission 25, the crimping work as described above can be executed after the clutch hub 50 is fixed to the planetary carrier 34, so that ease of assembly of the first planetary gear mechanism 30 and the clutch C4 including the clutch hub 50 can be maintained. Crimping the first and second pinion shafts 35 and 36 to the planetary carrier 34 allows the first and second pinion shafts 35 and 36 to be virtually integrated with the planetary carrier 34, so that the rigidity of the planetary carrier 34 can be increased.

Moreover, the first and second exposing portions 511 and 512 are formed so as to have the opening areas necessary and sufficient for execution of the crimping work described above. Therefore, the clutch hub 50 is favorably kept from decreasing in rigidity due to the formation of the first and second exposing portions 511 and 512, and the sufficient abutment area between the flange 51 and the planetary carrier 34, that is, a sufficient weld length between both members, is ensured so that the clutch hub 50 can be tightly fixed to the planetary carrier 34. In addition, the bridges 513 connecting the protruding portions 514 between the adjacent first and second exposing portions 511 and 512 are provided on the inner peripheral side of either of the first and second exposing portions 511 and 512, so that the rigidity of the clutch hub 50 can be further sufficiently ensured. As a result, in the case of the automatic transmission 25, ease of assembly is favorably maintained, and, at the same time, the rigidity of the planetary carrier 34 included in the first planetary gear mechanism 30 and the clutch hub 50 of the clutch C4 fixed to the planetary carrier 34 can be sufficiently ensured.

The first exposing portions 511 are formed by cutting out the flange 51 from the inner periphery toward the outer periphery thereof. The second exposing portions 512 are arranged further outward in the radial direction than the first exposing portions 511. The bridges 513 connect the protruding portions 514 between the adjacent first and second exposing portions 511 and 512 on the inner peripheral side of the second exposing portions 512. In this manner, by connecting the protruding portions 514 on the inner peripheral side of the second exposing portions 512 arranged further outward in the radial direction than the first exposing portions 511, the bridges 513 can be provided on the inner peripheral side of the second exposing portions 512 to ensure the rigidity of the clutch hub 50 while ensuring the opening areas of the second exposing portions 512. The bridges 513 can be used as supporting parts (fixing parts) while the first and second exposing portions 511 and 512 are processed, so that deformation of the flange 51 can be favorably reduced. As a result, the flange 51 can accurately abut on the surface of the planetary carrier 34, which includes the above-described crimp receiving portions 341c, and the clutch hub 50 can be more tightly fixed to the planetary carrier 34.

The structures of the planetary carrier 34 and the clutch hub 50 as described above can naturally be used in a single-pinion type planetary gear mechanism, in addition to in the double-pinion type first planetary gear mechanism 30 that includes the inner pinion gears 33a each meshing with the sun gear 31 and the outer pinion gears 33b each meshing with corresponding one of the inner pinion gears 33a and the ring gear 32. In this case, the first exposing portions 511 formed in the flange 51 of the clutch hub 50 may be formed as the same openings as the second exposing portions 512 of the present embodiment, and the first and second exposing portions 511 and 512 may be formed so as to be located substantially concentrically with each other.

Instead of arranging the annular oil receiver 70 inside the cylindrical portion 52 of the clutch hub 50, the carrier body 341 may be provided with oil passages that open on the inner peripheral side and communicate with the in-shaft oil passages 35o and 36o (shaft recesses 351a and 361a) of the first and second pinion shafts 35 and 36, and the oil for lubrication and cooling may be supplied through the oil passages to the inner and outer pinion gears 33a and 33b and the needle bearings 61 and 62. Moreover, the clutch hub 50 may be fixed to the carrier body 341 by a method (such as adhesive bonding) other than the welding. The projections 341t for supporting the flange 51 of the clutch hub 50 may be omitted from the carrier body 341.

The following describes correspondence between main elements in the embodiment described above and the main elements of the disclosure described in the summary of the disclosure. Specifically, in the embodiment described above, the first planetary gear mechanism 30 including the inner and outer pinion gears 33a and 33b and the planetary carrier 34 supporting the first and second pinion shafts 35 and 36 respectively inserted in the inner and outer pinion gears 33a and 33b corresponds to the “planetary gear mechanism”; the clutch C4 including the clutch hub 50 serving as a hub member and fixed to the planetary carrier 34 corresponds to the “friction engagement element”; the automatic transmission 25 including the first planetary gear mechanism 30 and the clutch C4 corresponds to the “transmission device”; the first and second pinion shafts 35 and 36 including the shaft recesses 351a and 361a recessed inward in the axial direction from the end surfaces thereof and the outer peripheral portions 352a and 362a surrounding the shaft recesses 351a and 361a correspond to the “pinion shafts”; the planetary carrier 34 including the carrier body 341 corresponds to the “planetary carrier”, where the carrier body 341 has the shaft support hole 341o supporting the ends 35a and 36a of the first and second pinion shafts 35 and 36, respectively, and includes the crimp receiving portions 341c provided around the shaft support holes 341o so as to receive part of the outer peripheral portions 352a and 362a expanded outward in the radial direction from the shaft recesses 351a and 361a; the clutch hub 50 including the annular flange 51 fixed to the surface of the carrier body 341 of the planetary carrier 34, which includes the crimp receiving portions 341c corresponds to the “hub member”; the first exposing portions 511 and the second exposing portions 512 correspond to the “first exposing portions” and the “second exposing portions”, the first and second exposing portions 511 and 512 being formed alternately with each other so as to expose at least part of the shaft recesses 351a and 361a and the outer peripheral portions 352a and 362a of the first and second pinion shafts 35 and 36 inserted into the shaft support holes 341o, and also to expose the crimp receiving portions 341c of the planetary carrier 34; and the bridges 513 connecting portions between the adjacent first and second exposing portions 511 and 512 on the inner peripheral side of either of the first and second exposing portions 511 and 512, that is, connecting the protruding portions 514, correspond to the “bridges”.

While the embodiments of the present disclosure have been described, the present disclosure is not in any way limited to the embodiments described above, but can naturally be variously modified within the breadth of the present disclosure. The above-described embodiments to carry out the disclosure are merely specific embodiments of the disclosure described in the summary of the disclosure, and do not limit the elements of the disclosure described in the summary of the disclosure.

### INDUSTRIAL APPLICABILITY

The present disclosure can be used in, for example, industries manufacturing transmission devices.

1. A transmission device comprising
a planetary gear mechanism including a plurality of pinion gears and a planetary carrier supporting a plurality of pinion shafts respectively inserted into the pinion gears, and also including a friction engagement element including a hub member fixed to the planetary carrier, wherein
an end of each of the pinion shafts is provided with a shaft recess recessed inward in an axial direction from a surface of the end, and provided with an outer peripheral portion surrounding the shaft recess,
the planetary carrier has a plurality of shaft support holes each supporting the end of the pinion shaft, and includes crimp receiving portions provided around the shaft support holes so as to receive part of the outer peripheral portions each expanded outward in a radial direction from the shaft recess,
the hub member includes an annular flange fixed to a surface of the planetary carrier, which includes the crimp receiving portions, and
the flange is provided with first exposing portions and second exposing portions arranged alternately with each other, and is also provided with a plurality of bridges, the first and second exposing portions exposing at least part of the shaft recesses and the outer peripheral portions of the pinion shafts inserted into the shaft support holes, and also exposing the crimp receiving portions of the planetary carrier, and the bridges connecting portions between the adjacent first and second exposing portions on an inner peripheral side of either of the first and second exposing portions.

2. The transmission device according to claim 1, wherein
the first exposing portions are formed by cutting out the flange from an inner periphery toward an outer periphery of the flange,
the second exposing portions are arranged further outward in the radial direction than the first exposing portions, and
the bridges connect portions between the adjacent first and second exposing portions on the inner peripheral side of the second exposing portions.

3. The transmission device according to claim 2, wherein
the pinion gears include a plurality of inner pinion gears each meshing with a sun gear and a plurality of outer pinion gears each meshing with corresponding one of the inner pinion gears and a ring gear,
the first exposing portions expose at least part of the shaft recesses and the outer peripheral portions of the pinion shafts inserted into the inner pinion gears, and also expose the crimp receiving portions of the planetary carrier, and
the second exposing portions expose at least part of the shaft recesses and the outer peripheral portions of the pinion shafts inserted into the outer pinion gears, and also expose the crimp receiving portions of the planetary carrier.

4. The transmission device according to claim 3, wherein
the planetary carrier includes a plurality of projections that support the flange of the hub member,
among the portions between the adjacent first and second exposing portions on the inner peripheral side of the second exposing portions of the flange, portions closer to the inner and outer pinion gears that do not mesh with each other have a larger peripheral length than that of other portions closer to the inner and outer pinion gears that mesh with each other, and are supported by the projections in the radial direction.

5. The transmission device according to claim 4, wherein
the hub member includes a cylindrical portion that extends from the outer peripheral portion of the flange in the axial direction and is provided with splines to which an inner peripheral portion of a friction engagement plate is fitted, and the cylindrical portion is arranged so as to overlap with the pinion shafts corresponding to the either of the first and second exposing portions viewed from the axial direction.

6. The transmission device according to claim 5, wherein
each of the pinion shafts is provided with an in-shaft oil passage extending from the shaft recess toward another end of the pinion shaft,
an annular oil receiver is disposed inside the hub member, and
the oil receiver includes an oil collecting portion that receives oil splashed from inside and a plurality of insert portions each having an oil passage communicating with the oil collecting portion and inserted into the in-shaft oil passage through corresponding one of the first or second exposing portions and the shaft recess.

7. The transmission device according to claim 6, wherein the hub member is fixed by welding to the planetary carrier.

8. The transmission device according to claim 4, wherein
each of the pinion shafts is provided with an in-shaft oil passage extending from the shaft recess toward another end of the pinion shaft,
an annular oil receiver is disposed inside the hub member, and
the oil receiver includes an oil collecting portion that receives oil splashed from inside and a plurality of insert portions each having an oil passage communicating with the oil collecting portion and inserted into the in-shaft oil passage through corresponding one of the first or second exposing portions and the shaft recess.

9. The transmission device according to claim 3, wherein
the hub member includes a cylindrical portion that extends from the outer peripheral portion of the flange in the axial direction and is provided with splines to which an inner peripheral portion of a friction engagement plate is fitted, and the cylindrical portion is arranged so as to overlap with the pinion shafts corresponding to the either of the first and second exposing portions viewed from the axial direction.

10. The transmission device according to claim 9, wherein
each of the pinion shafts is provided with an in-shaft oil passage extending from the shaft recess toward another end of the pinion shaft,
an annular oil receiver is disposed inside the hub member, and
the oil receiver includes an oil collecting portion that receives oil splashed from inside and a plurality of insert portions each having an oil passage communicating with the oil collecting portion and inserted into the in-shaft oil passage through corresponding one of the first or second exposing portions and the shaft recess.

11. The transmission device according to claim 3, wherein
each of the pinion shafts is provided with an in-shaft oil passage extending from the shaft recess toward another end of the pinion shaft,
an annular oil receiver is disposed inside the hub member, and
the oil receiver includes an oil collecting portion that receives oil splashed from inside and a plurality of insert portions each having an oil passage communicating with the oil collecting portion and inserted into the in-shaft oil passage through corresponding one of the first or second exposing portions and the shaft recess.

12. The transmission device according to claim 2, wherein
the hub member includes a cylindrical portion that extends from the outer peripheral portion of the flange in the axial direction and is provided with splines to which an inner peripheral portion of a friction engagement plate is fitted, and the cylindrical portion is arranged so as to overlap with the pinion shafts corresponding to the either of the first and second exposing portions viewed from the axial direction.

13. The transmission device according to claim 12, wherein
each of the pinion shafts is provided with an in-shaft oil passage extending from the shaft recess toward another end of the pinion shaft,
an annular oil receiver is disposed inside the hub member, and
the oil receiver includes an oil collecting portion that receives oil splashed from inside and a plurality of insert portions each having an oil passage communicating with the oil collecting portion and inserted into the in-shaft oil passage through corresponding one of the first or second exposing portions and the shaft recess.

14. The transmission device according to claim 2, wherein
each of the pinion shafts is provided with an in-shaft oil passage extending from the shaft recess toward another end of the pinion shaft,
an annular oil receiver is disposed inside the hub member, and
the oil receiver includes an oil collecting portion that receives oil splashed from inside and a plurality of insert portions each having an oil passage communicating with the oil collecting portion and inserted into the in-shaft oil passage through corresponding one of the first or second exposing portions and the shaft recess.

15. The transmission device according to claim 1, wherein
the hub member includes a cylindrical portion that extends from the outer peripheral portion of the flange in the axial direction and is provided with splines to which an inner peripheral portion of a friction engagement plate is fitted, and the cylindrical portion is arranged so as to overlap with the pinion shafts corresponding to the either of the first and second exposing portions viewed from the axial direction.

16. The transmission device according to claim 15, wherein
each of the pinion shafts is provided with an in-shaft oil passage extending from the shaft recess toward another end of the pinion shaft,
an annular oil receiver is disposed inside the hub member, and
the oil receiver includes an oil collecting portion that receives oil splashed from inside and a plurality of insert portions each having an oil passage communicating with the oil collecting portion and inserted into the in-shaft oil passage through corresponding one of the first or second exposing portions and the shaft recess.

17. The transmission device according to claim 1, wherein
each of the pinion shafts is provided with an in-shaft oil passage extending from the shaft recess toward another end of the pinion shaft,
an annular oil receiver is disposed inside the hub member, and
the oil receiver includes an oil collecting portion that receives oil splashed from inside and a plurality of insert portions each having an oil passage communicating with the oil collecting portion and inserted into the in-shaft oil passage through corresponding one of the first or second exposing portions and the shaft recess.

18. The transmission device according to claim 1, wherein the hub member is fixed by welding to the planetary carrier.
